(19) United States
(12) Patent Application Publication
(10) Pub. No.: US 2022/0182738 A1
(43) Pub. Date: Jun. 9, 2022

(54) DEVICE AND METHOD FOR PROVIDING CONTENTS BASED ON AUGMENTED REALITY

(71) Applicant: XrisP Co., Ltd., Seoul (KR)

(72) Inventor: Dae Gyun SOHN, Seoul (KR)

(73) Assignee: XrisP Co., Ltd., Seoul (KR)

(21) Appl. No.: 17/537,409

(22) Filed: Nov. 29, 2021

(30) Foreign Application Priority Data
Dec. 4, 2020 (KR) 10-2020-0168166

(51) Int. Cl. H04N 21/8545; H04N 21/8541; G06T 19/00; H04N 21/81

(52) U.S. Cl. CPC H04N 21/8545; H04N 21/816; G06T 19/006; H04N 21/8541

(57) ABSTRACT

The present disclosure relates to a device and method for providing content based on augmented reality, wherein more specifically, the device for providing content may include a content generating unit that generates content provided to a user according to a user's selection, a space forming unit that defines a content execution space in which the content are performed based on the content, a content providing unit that provides the content to the user according to an input of the previously generated content in the content execution space of the user, and a story development unit that develops a story of the content in the content execution space through an interactive operation between the user and the content.

### CROSS-REFERENCE TO PRIOR APPLICATION

This application claims priority to Korean Patent Application No. 10-2020-0168166 (filed on Dec. 4, 2020), which is hereby incorporated by reference in its entirety.

### BACKGROUND

The present disclosure relates to a technology of providing content based on augmented reality, and more particularly, to a device and method for providing content based on augmented reality capable of providing content according to a user's selection and providing a content execution space for executing content to the user.

Childhood is a period of development of five senses. Childhood, which is a period of human growth after infancy, is an important period in which development progresses in all areas such as motor development, social development that begins to distinguish objects and grows, and language development that includes emotional expression.

Parents need to create good growth activities so that their children can grow through vigorous activities during their childhood. However, with the recent development of society and technology, children's attention has been focused on digital media, and children have a rather static lifestyle. These lifestyle habits cause not only physical growth but also social problems such as deterioration in social nature, and the present disclosure is to provide a technology of using digital media that can attract children's attention, but leading their growth.

Korea Patent No. 10-2111531 (May 11, 2020) relates to a system for providing a medical experience in a hospital based on VR or AR, and more specifically, to a system for providing a medical experience including: a head mounted display (HMD) that is worn on a patient's head and displays a virtual reality (VR) or augmented reality (AR) screen; an all-in-one device that is combined with a hand gesture recognition sensor that recognizes a patient's hand motion; and a computer that communicates with a guardian viewing monitor that a patient's guardian and a medical staff view and the all-in-one device and provides medical experience content, which enable a virtual experience of a treatment process in the hospital, to the all-in-one device, when receiving a patient's voice signal or hand motion signal sensed by the all-in-one device, provides interactive treatment experience content corresponding to the received patient's voice signal or hand motion signal to the all-in-one device, and mirrors the same screen as a content screen provided to the all-in-one device and displays the mirrored screen on a monitor for parental viewing.

Korean Patent Registration No. 10-1842600 (Mar. 21, 2018) relates to a virtual reality system and a method for providing virtual reality using the same, and more specifically, to a virtual reality system including: a mobile HMD located within a local area; a plurality of kinects that generate skeleton data by sensing a user motion within the local area; a plurality of clients that are disposed in the local area to be connected to the plurality of kinects one-to-one, collect the skeleton data from the connected kinects, and divide the skeleton data for each user to generate the divided skeleton data; and a virtual reality server that collects the divided skeleton data from the plurality of clients, generates a world coordinate system of a virtual space based on the divided skeleton data, corrects the skeleton data based on location information of the mobile HMD in the local area and the world coordinate system, and converts the corrected skeleton data and provides the converted data to the mobile HMD.

### PRIOR ART

### Patent Literature

Korean Patent No. 10-2111531 (May 11, 2020)
Korean Patent No. 10-1842600 (Mar. 21, 2018)

### SUMMARY

An embodiment of the present disclosure is to provide a space for users to enjoy content in accordance with content by providing the user with a space for executing the content having a plurality of dimensions.

An embodiment of the present disclosure is to provide a user with content that can improve user's spatial perception ability.

An embodiment of the present disclosure intends to provide a user with content that can express a corresponding reaction according to a user's actual operation of content implemented in virtual reality.

In an aspect, a device for providing content based on augmented reality includes: a content generating unit that generates content provided to a user according to a user's selection; a space forming unit that defines a content execution space in which the content are performed based on the content; a content providing unit that provides the content to the user according to an input of the previously generated content in the content execution space of the user; and a story development unit that develops a story of the content in the content execution space through an interactive operation between the user and the content.

The content may be configured by being divided into a plurality of levels of difficulty according to the user's personal information, and configured to have a time limit based on a specific time according to the user's selection.

The content generation unit may generate the content so that the content execution space is connected through edge blending based on the content execution space, and perform the edge blending through masking.

The space forming unit may determine a space dimension for recognizing a user's input according to a dimension in which the content is configured, and form the space where the user's input is not recognized as an empty space in which the content is not input to define the content execution space.

The content generation unit may connect each spatial dimension through illuminance smoothing with respect to an edge to which each spatial dimension recognizing the user's input is connected.

The content providing unit may implement an interactive point of the content on the content execution space.

The story development unit may output a preset result value according to the user's operation with respect to the interactive point, and the interactive operation may include the user's interaction with the content.

The disclosed technology may have the following effects. However, since a specific embodiment is not construed as including all of the following effects or only the following effects, it should not be understood that the scope of the disclosed technology is limited to the specific embodiment.

A device for providing content based on augmented reality according to an embodiment of the present disclosure may provide a content execution space having a plurality of dimensions to a user, thereby providing a space for enjoying the corresponding content according to the content.

A device for providing content based on augmented reality according to an embodiment of the present disclosure may provide a user with content that can improve the user's spatial perception ability.

A device for providing content based on augmented reality according to an embodiment of the present disclosure may provide a user with content capable of expressing a corresponding reaction according to the user's actual operation of the content implemented in virtual reality.

In another aspect, a method for providing content based on augmented reality includes: generating content provided to a user according to a user's selection; forming a space defining a content execution space in which the content is performed based on the content; providing the content to the user according to an input of the previously generated content in the content execution space of the user; and developing a story of the content in the content execution space through an interactive operation between the user and the content.

### BRIEF DESCRIPTION OF THE DRAWINGS

FIG. 1 is a block diagram illustrating a physical configuration of a device for providing content based on augmented reality according to an embodiment.

FIG. 2 is a block diagram illustrating a functional configuration of the device for providing content based on augmented reality according to an embodiment.

FIGS. 3A to 3C are diagrams illustrating a space in which the device for providing content based on augmented reality is implemented according to an embodiment.

FIGS. 4A to 4M are diagrams for explaining content provided in the device for providing content based on augmented reality according to an embodiment.

FIG. 5 is a diagram illustrating a sequence of a method for providing content based on augmented reality according to an embodiment.

### DESCRIPTION OF EXEMPLARY EMBODIMENTS

Since the description of the present disclosure is merely an embodiment for structural or functional explanation, the scope of the present disclosure should not be construed as being limited by the embodiments described in the text. That is, since the embodiments may be variously modified and may have various forms, the scope of the present disclosure should be construed as including equivalents capable of realizing the technical idea. In addition, a specific embodiment is not construed as including all the objects or effects presented in the present disclosure or only the effects, and therefore the scope of the present disclosure should not be understood as being limited thereto.

On the other hand, the meaning of the terms described in the present application should be understood as follows.

Terms such as “first” and “second” are intended to distinguish one component from another component, and the scope of the present disclosure should not be limited by these terms. For example, a first component may be named a second component and the second component may also be similarly named the first component.

It is to be understood that when one element is referred to as being “connected to” another element, it may be connected directly to or coupled directly to another element or be connected to another element, having the other element intervening therebetween. On the other hand, it is to be understood that when one element is referred to as being “connected directly to” another element, it may be connected to or coupled to another element without the other element intervening therebetween. Meanwhile, other expressions describing a relationship between components, that is, “between,” “directly between,” “neighboring to,” “directly neighboring to,” and the like, should be similarly interpreted.

It should be understood that the singular expression include the plural expression unless the context clearly indicates otherwise, and it will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

In each step, an identification code (for example, a, b, c, and the like) is used for convenience of description, and the identification code does not describe the order of each step, and each step may be different from the specified order unless the context clearly indicates a particular order. That is, the respective steps may be performed in the same sequence as the described sequence, be performed at substantially the same time, or be performed in an opposite sequence to the described sequence.

The present disclosure can be embodied as computer readable code on a computer-readable recording medium, and the computer-readable recording medium includes all types of recording devices in which data can be read by a computer system. An example of the computer readable recording medium may include a read only memory (ROM), a random access memory (RAM), a compact disk read only memory (CD-ROM), a magnetic tape, a floppy disk, an optical data storage, or the like. In addition, the computer readable recording medium may be distributed in computer systems connected to each other through a network, such that the computer readable codes may be stored in a distributed scheme and executed.

Unless defined otherwise, all the terms used herein including technical and scientific terms have the same meaning as meanings generally understood by those skilled in the art to which the present disclosure pertains. It should be understood that the terms defined by the dictionary are identical with the meanings within the context of the related art, and they should not be ideally or excessively formally defined unless the context clearly dictates otherwise.

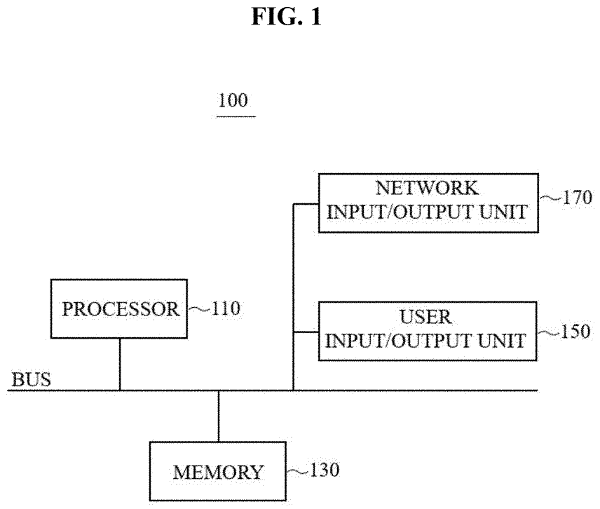

FIG. 1 is a block diagram illustrating a physical configuration of a device 100 for providing contents based on augmented reality according to an embodiment.

Referring to FIG. 1, a device 100 for providing content based on augmented reality 100 may be implemented to include a processor 110, a memory 130, a user input/output unit 150, and a network input/output unit 170.

The processor 110 may execute a procedure of generating content according to a space, providing a previously generated content to the content execution space, recognizing a user's operation in the corresponding content execution space, and outputting a response corresponding to the user's operation, and may manage the memory 130 that is read or written throughout the process, and schedule a synchronization time between a volatile memory and a non-volatile memory in the memory 130 The processor 110 may control the overall operation of the device 100 for providing content based on augmented reality, and may be electrically connected to the memory 130, the user input/output unit 150, and the network input/output unit 170 to control a data flow therebetween. The processor 110 may be implemented as a central processing unit (CPU) of the device 100 for providing content based on augmented reality.

The memory 130 may be implemented as a non-volatile memory, such as a solid state drive (SSD) or a hard disk drive (HDD), and may include an auxiliary storage device used to store overall data necessary for the device 100 for providing content based on augmented reality and may include a main storage device implemented as a volatile memory such as a random access memory (RAM).

The user input/output unit 150 may include an environment for receiving user input and an environment for outputting specific information to a user. For example, the user input/output unit 150 may include an input device including an adapter such as a touch pad, a touch screen, an on-screen keyboard, or a pointing device, and an output device including an adapter such as a monitor or a touch screen. In an embodiment, the user input/output unit 150 may correspond to a computing device accessed through remote access, and in this case, the device 100 for providing content based on augmented reality may be performed as a server.

The network input/output unit 170 includes an environment for connecting with an external device or a system through a network, and may include an adapter for communications such as a local area network (LAN), a metropolitan area network (MAN), a wide area network (WAN), a value added network (VAN), and the like.

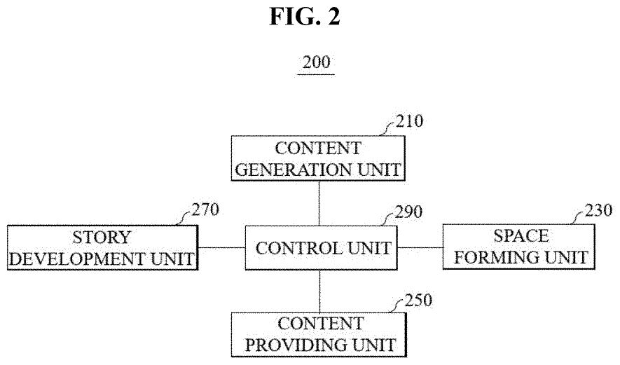

FIG. 2 is a block diagram for explaining a functional configuration of the device 100 for providing contents based on augmented reality according to an embodiment.

Referring to FIG. 2, the device 100 for providing content based on augmented reality may include a content generation unit 210, a space forming unit 230, a content providing unit 250, a story development unit 270, and a control unit 290.

The content generation unit 210 may generate content provided to the user according to the user's selection. For example, the content generation unit 210 may generate content provided as a series according to a user's selection. Specifically, the content generation unit 210 may generate first content, second content, and third content as one content group, and may also generate the first content, the third content, and fourth content as one content group. For example, one content group may be determined according to a user's policy.

The content may be configured by being divided into a plurality of degrees of difficulty according to the user's personal information, and configured to have a time limit based on a specific time according to the user's selection. For example, the content may be determined by a plurality of levels of difficulty according to a user's age. Specifically, even if the content is formed with the same story, it may be composed of different levels of difficulty according to the user's age information. In addition, each content may have an age recommended to the user. Specifically, the first content may have a recommended age of 5 years or more, and the second content may have a recommended age of 7 years or more.

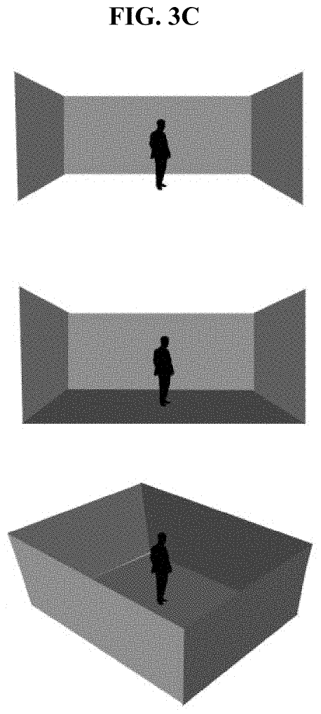

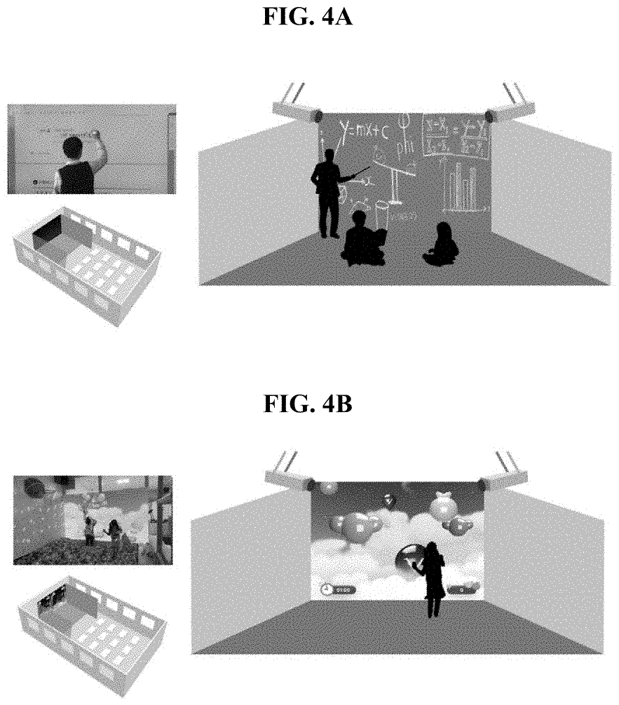

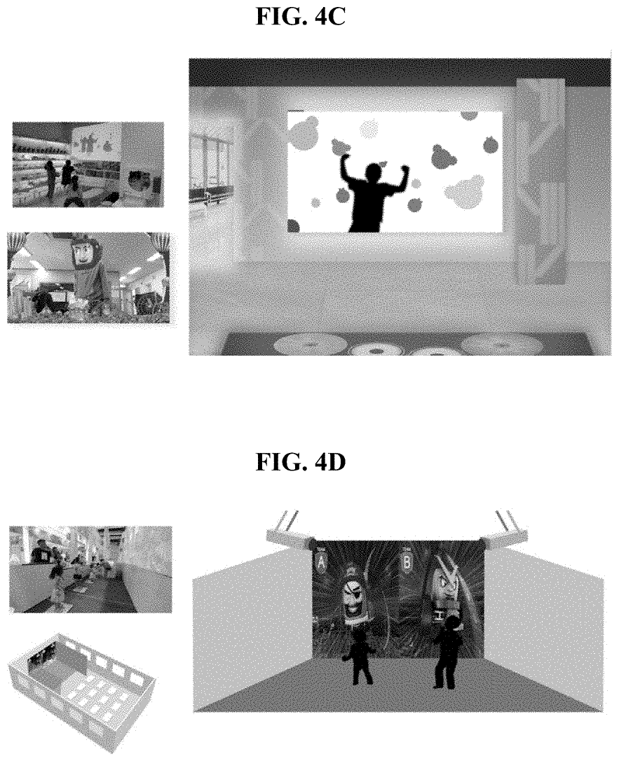

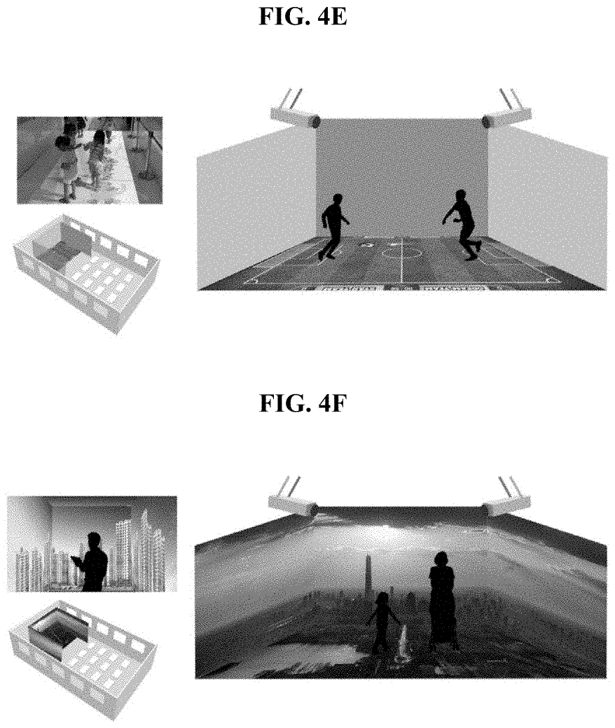

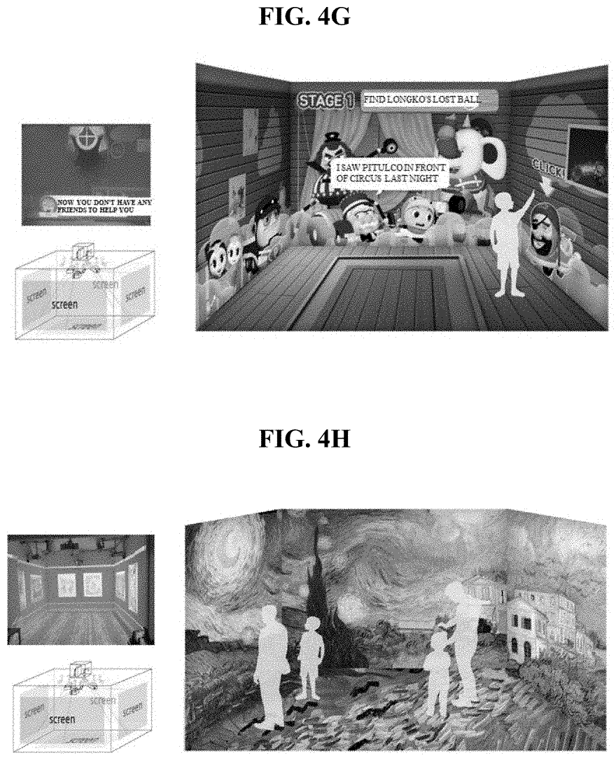

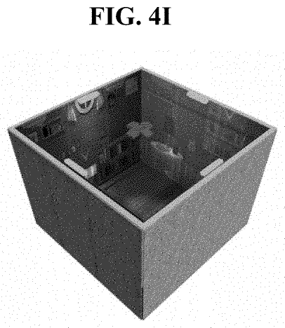

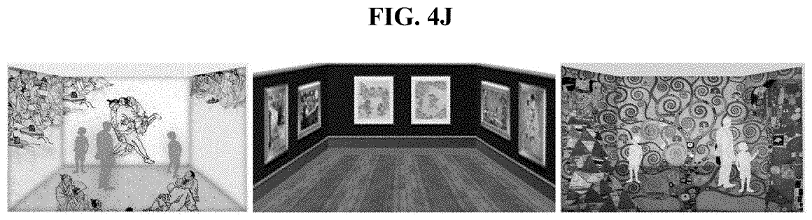

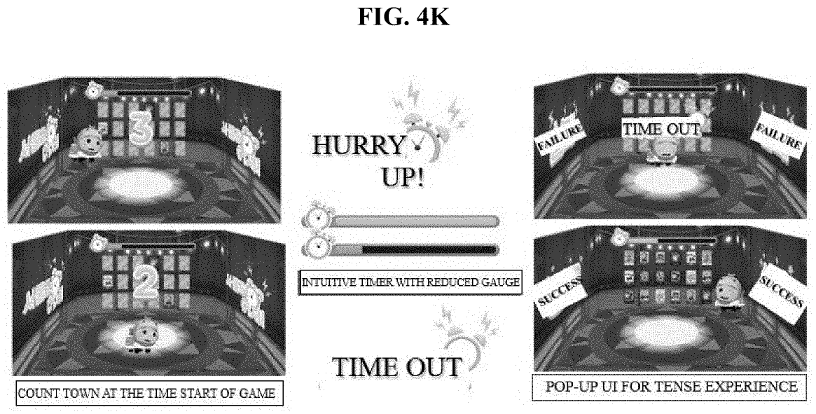

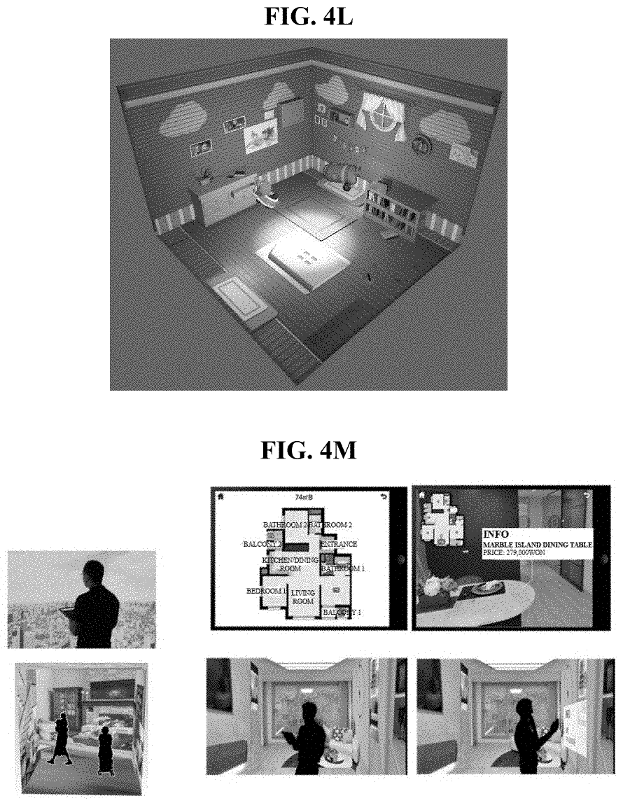

According to one embodiment, the content generation unit 210 may generate the content so that the content execution space may be connected through edge blending based on the content execution space, and perform the edge blending through masking. For example, the content generation unit 210 may perform the edge blending on edges where dimensions overlap according to the dimension of the content execution space. The content generation unit 210 may generate content so that the corresponding part is not too bright by adjusting brightness of a specific ratio compared to original brightness for the edge where the dimensions overlap. For example, the masking of the edge blending may mean deleting the original data of an edge to which each content execution space is connected and connecting it with data having similar saturation, texture, and color so that the corresponding edge can be smoothly connected. Also, the content generation unit 210 may generate content according to sizes of each dimension. For example, referring to FIGS. 4A to 4M, the content may be divided into a main dimension and a sub-dimension where the content is executed, and the content generation unit 210 may configure the content size of the main dimension and the content size of the sub-dimension differently. In addition, the content generation unit 210 may generate the corresponding content by differently configuring a display method such as the brightness of the corresponding content according to the texture and color of the content execution space defined by the space forming unit 230. For example, the content generation unit 210 may generate content having high brightness in a content execution space having a dark texture. As another example, when an area of one dimension of the corresponding content execution space is narrow, the content generation unit 210 may reduce the content to be displayed in the corresponding dimension, and for the remaining dimensions, generate the corresponding content to be the same as the original size.

In one embodiment, the content generation unit 210 may connect each spatial dimension through illuminance smoothing with respect to an edge to which each spatial dimension recognizing the user's input is connected. The illuminance smoothing may refer to an operation of projecting the content by adjusting the brightness of the edge portion to which each spatial dimension is connected.

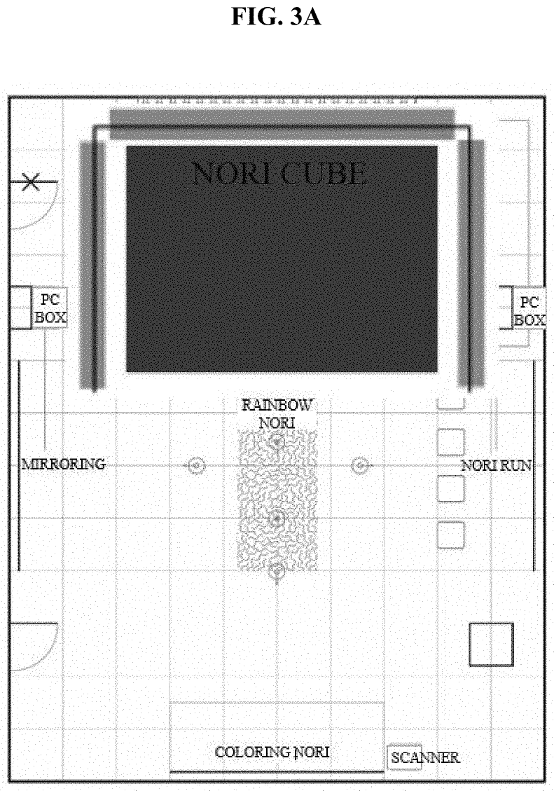

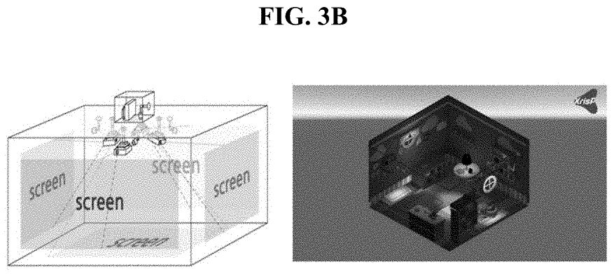

The space forming unit 230 may define the content execution space in which content is performed based on the content. Referring to FIGS. 3A to 3C and 4A to 4M, the content execution space may be determined by a dimension and a size of a space in which the corresponding content is projected. For example, the space forming unit 230 may define the corresponding content execution space in one dimension when the corresponding content requires only one dimension. As another example, when the corresponding content requires a plurality of dimensions, the space forming unit 230 may define the corresponding content execution space according to the corresponding dimension.

In one embodiment, the space forming unit 230 may determine a space dimension for recognizing a user's input according to the dimension in which the content is configured, and forms the space where the user's input is not recognized as an empty space in which the content is not input to define the content execution space. For example, the space forming unit 230 defines a space that can recognize a user's input for a content execution space defined in a dimension in which content is configured, and define the remaining space as a space in which a user input cannot be received.

The content providing unit 250 may provide the content to the user according to the input of the previously generated content in the content execution space of the user. For example, the content providing unit 250 may provide the corresponding content to the corresponding user according to the position of the user's content execution space. More specifically, the content providing unit 250 may provide the previously formed content to the user as the user enters the content execution space defined by the space forming unit 230.

In one embodiment, the content providing unit 250 may implement an interactive point of the content on the content execution space. The interactive point may correspond to a point in the corresponding content that can accept a user's input. For example, the interactive point may be a point capable of detecting a user's touch, voice, movement, or the like.

The story development unit 270 may develop the story of the content in the content execution space through an interactive operation between the user and the content. For example, the story development unit 270 may develop the story so that each of the following operations is performed according to the user's operation of the previously generated corresponding content. More specifically, the story development unit 270 may provide the user with the following operations according to the user's content execution.

In one embodiment, the story development unit 270 may output a preset result value according to the user's operation on the interactive point. For example, the story development unit 270 may develop the story by showing the user an operation previously determined for the corresponding content in response to the user's touch or the like.

In one embodiment, the interactive operation may include the user's interaction with the content. For example, the interaction may include any user operation that the device may receive input, such as the user's touch, story, and movement.

The controller 290 controls the overall operation of the device 100 for providing content based on augmented reality 130, and may manage a control flow or a data flow between the content generation unit 210, the space forming unit 230, the content providing unit 250, and the story development unit 270.

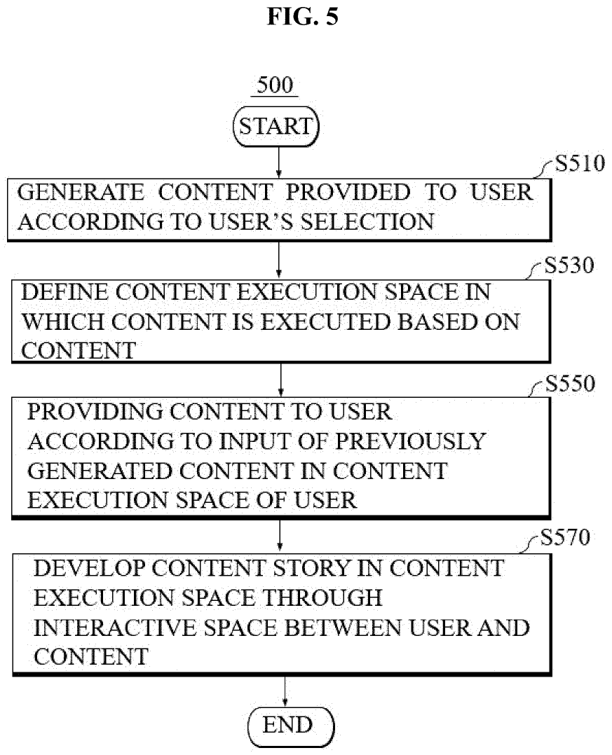

FIG. 5 is a diagram illustrating a sequence of a method for providing contents based on augmented reality according to an embodiment.

Referring to FIG. 5, the method for providing content based on augmented reality may generate content provided to the user according to the user's selection through the content generation unit 210 (S510).

The method for providing content based on augmented reality may define a content execution space in which content is performed based on the content through the space forming unit 230 (S530).

The method for providing content based on augmented reality may provide the content to the user according to the user's input in the content execution space of the previously generated content through the content providing unit 250 (S550).

The method for providing content based on augmented reality may develop the story of the content in the content execution space through the interactive operation between the user and the content through the story development unit 270 (S570).

Although exemplary embodiments of the present disclosure have been disclosed hereinabove, it may be understood by those skilled in the art that the present disclosure may be variously modified and altered without departing from the scope and spirit of the present disclosure described in the following claims.

What is claimed is:

1. A device for providing content based on augmented reality, comprising:
a content generating unit that generates content provided to a user according to a user's selection;
a space forming unit that defines a content execution space in which the content are performed based on the content;
a content providing unit that provides the content to the user according to an input of the previously generated content in the content execution space of the user; and
a story development unit that develops a story of the content in the content execution space through an interactive operation between the user and the content.

2. The device of claim 1, wherein the content is configured by being divided into a plurality of levels of difficulty according to the user's personal information, and configured to have a time limit based on a specific time according to the user's selection.

3. The device of claim 1, wherein the content generation unit generates the content so that the content execution space is connected through edge blending based on the content execution space, and performs the edge blending through masking.

4. The device of claim 1, wherein the space forming unit determines a space dimension for recognizing a user's input according to a dimension in which the content is configured, and forms the space where the user's input is not recognized as an empty space in which the content is not input to define the content execution space.

5. The device of claim 4, wherein the content generation unit connects each spatial dimension through illuminance smoothing with respect to an edge to which each spatial dimension recognizing the user's input is connected.

6. The device of claim 1, wherein the content providing unit implements an interactive point of the content on the content execution space.

7. The device of claim 6, wherein the story development unit outputs a preset result value according to the user's operation with respect to the interactive point, and
the interactive operation includes the user's interaction with the content.

8. A method for providing content based on augmented reality, comprising:
generating content provided to a user according to a user's selection;
forming a space defining a content execution space in which the content is performed based on the content;
providing the content to the user according to an input of the previously generated content in the content execution space of the user; and
developing a story of the content in the content execution space through an interactive operation between the user and the content.
